(19) United States
(12) Patent Application Publication
(10) Pub. No.: US 2015/0346145 A1
(43) Pub. Date: Dec. 3, 2015

(54) DEVICE FOR PERFORMING ELECTROPHORESIS PRODUCING MIRROR COPIES OF SEPARATED PROTEINS BY USING THE SAME GEL AND THE SAME SAMPLES

(71) Applicant: Abraham Shtevi, Omer (IL)

(72) Inventor: Abraham Shtevi, Omer (IL)

(21) Appl. No.: 14/654,559

(22) PCT Filed: Dec. 19, 2013
(86) PCT No.: PCT/IB2013/061142

§ 371 Date: Jun. 22, 2015

Related U.S. Application Data
(60) Provisional application No. 61/748,206, filed on Jan. 2, 2013.

(51) Int. Cl. G01N 27/447

(52) U.S. Cl. CPC G01N 27/44704; G01N 27/44747

(57) ABSTRACT

A gel matrix device for performing polyacrylamide gel electrophoresis, comprising: a back plate having spacers on both vertical sides thereof; a front plate, shorter than the back plate; and a middle plate having a middle part shorter than the front plate, two side parts having the same height as the back plate and spacers on both vertical sides thereof, the spacers having the same height as the back plate spacers, wherein said middle plate divides the volume between said back and front plates into two compartments and wherein each one of said two compartments comprises gel up to the height of said middle plate, and wherein the gel continues above the middle plate in an area common to the two compartments, said area comprising wells for sample loading.

### CROSS-REFERENCE TO RELATED PATENT APPLICATIONS

This patent application claims priority from and is related to U.S. Provisional Patent Application Ser. No. 61/748,206, filed 2 Jan. 2013, this U.S. Provisional Patent Application incorporated by reference in its entirety herein.

### FIELD OF THE INVENTION

The present invention is in the field of electrophoresis and more particularly improvement to the SDS-PAGE process of protein separation based on size.

### BACKGROUND

Polyacrylamide gel electrophoresis (PAGE) is used for separating proteins ranging in size from 5 to 2,000 kDa due to the uniform pore size provided by the polyacrylamide gel. Pore size is controlled by controlling the concentrations of acrylamide and bisacrylamide used in creating a gel. Electrophoresis is a process which enables the sorting of molecules based on size. Using an electric field protein molecules migrate through a gel made of polyacrylamide. The molecules being sorted are dispensed into wells in the gel material. The gel is placed in an electrophoresis chamber, which is then connected to a power source. When the electric current is applied, the larger molecules move more slowly through the gel while the smaller molecules move faster. The different sized molecules form distinct bands on the gel.[1][1] Shapiro A L, Viñuela E, Maizel J V Jr. (September 1967). “Molecular weight estimation of polypeptide chains by electrophoresis in SDS-polyacrylamide gels.” Biochem Biophys Res Commun. 28(5): 815-820.

The term “gel” in this instance refers to the matrix (either produced in the lab or purchased ready to use) used to contain, and then separate the target molecules. In most cases, the gel is a crosslinked polymer whose composition and porosity is chosen based on the specific weight of the target to be analyzed. When separating proteins the gel is usually composed of different concentrations of acrylamide and a cross-linker, producing different sized mesh networks of polyacrylamide.

FIG. 1 is a schematic drawing showing the existing devices and process of performing the PAGE procedure. The matrix 100 is composed of 2 plates, 2 spacers, and a comb. The thickness of the gel inserted between the 2 plates is determined by the thickness of the spacers, and these range in size from 0.5 mm to 1.5 mm. The comb creates small rectangular wells in the gel, and is removed prior to using the gel. Typically the gel is prepared with two different compositions of acrylamide—the bottom gel is where the proteins are separated out, and the top gel is where they are loaded. If produced in the lab, the plates are made of durable, reusable glass, but if purchased then the whole construct is made of plastic and is disposable. The entire precast construct including the plates and the spacers, is about 5-6 mm thick and 10 cm×10 cm in side (although there are now new standards popping up as well).

The chamber is designed in such a way that two gel matrices, placed side by side form an internal bath that is separate from the external bath. Once these are in place both internal and external baths are filled with SDS-PAGE running buffer (FIG. 1). Note that if only one gel matrix is required, a plastic barrier of the same dimensions as the gel matrix is placed in the chamber to create the inner bath.

Once set up, the samples 130 are loaded into the wells. The samples are mixed with a heavy solution (called Laemmli sample buffer) and sink to the bottom of the wells. Once the samples are all loaded an electric current is run through the buffer 140. Since the only connection between the upper bath and the lower bath is through the gel, the electricity travels through the gel and this moves the protein samples down the gel. Once the samples have travelled down the gel, the electricity is stopped 150 and the apparatus taken apart. The gel can then be treated in a number of ways—it can be stained and ‘colored’ so that all the proteins become visible, or can be checked with specific antibodies (although this requires further processing of the gel). In short, it is quick, simple and provides important information regarding the size and composition of protein samples. FIG. 2 shows samples of stained gels including molecular ladders and proteins of various sizes.

The biggest limitation of the currently used approach is that 1 well=1 sample=1 data set. This implies that if the gel is stained it cannot be tested with antibodies, and if it is tested with antibody A, it cannot be tested with antibody B and so on. If the sample is to be tested using 2 different methodologies one simply has to run two gels. This implies that the sample has to be loaded twice and two gels used. The resulting two gels cannot even be compared since they are independent experiments and there will always be variance between one gel and the other.

### SUMMARY

According to an aspect of the present invention there is provided a gel matrix device for performing polyacrylamide gel electrophoresis, comprising: a back plate having spacers on both vertical sides thereof; a front plate, shorter than the back plate; and a middle plate having a middle part shorter than the front plate, two side parts having the same height as the back plate and spacers on both vertical sides thereof, the spacers having the same height as the back plate spacers, wherein said middle plate divides the volume between said back and front plates into two compartments and wherein each one of said two compartments comprises gel up to the height of said middle plate, and wherein the gel continues above the middle plate in an area common to the two compartments, said area comprising wells for sample loading.

According to another aspect of the present invention there is provided a method of producing a gel matrix device for performing polyacrylamide gel electrophoresis, comprising: providing a back plate having spacers on both vertical sides thereof; providing a front plate, shorter than the back plate; and providing a middle plate shorter than the front plate and having spacers on both vertical sides thereof, the spacers having the same height as the back plate spacers, wherein said middle plate divides the volume between said back and front plates into two compartments; creating a structure by attaching said three plates; sealing the sides of the structure with spacers; removably sealing the bottom of the structure; filling the structure with a solution to be polymerized; and inserting a comb at the top of the structure.

According to yet another aspect of the present invention there is provided a method of performing polyacrylamide gel electrophoresis, comprising: providing the gel matrix device of claim 1; removing the comb wells formed in the upper part of the gel; loading the gel matrix device into a gel chamber and adding running buffer to internal and external baths; mixing protein samples to be analyzed with Laemmli sample buffer and loading into the wells; and running an electric current through the buffer, whereby the protein samples move down the gel and are divided between both compartments.

The gels loaded into the two compartments may have identical or different compositions.

Each spacer may have a fixed thickness.

At least one spacer may have a gradient thickness.

The back plate spacers and the middle plate spacers may have identical or different thicknesses.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic drawing showing existing devices and process of performing the PAGE procedure;

FIG. 2 shows samples of stained gels including molecular ladders and proteins of various sizes;

FIGS. 3A through 3E are schematic drawing showing the gel matrix device according to the present invention; and

FIG. 4 shows encouraging results received from an initial prototype according to the present invention.

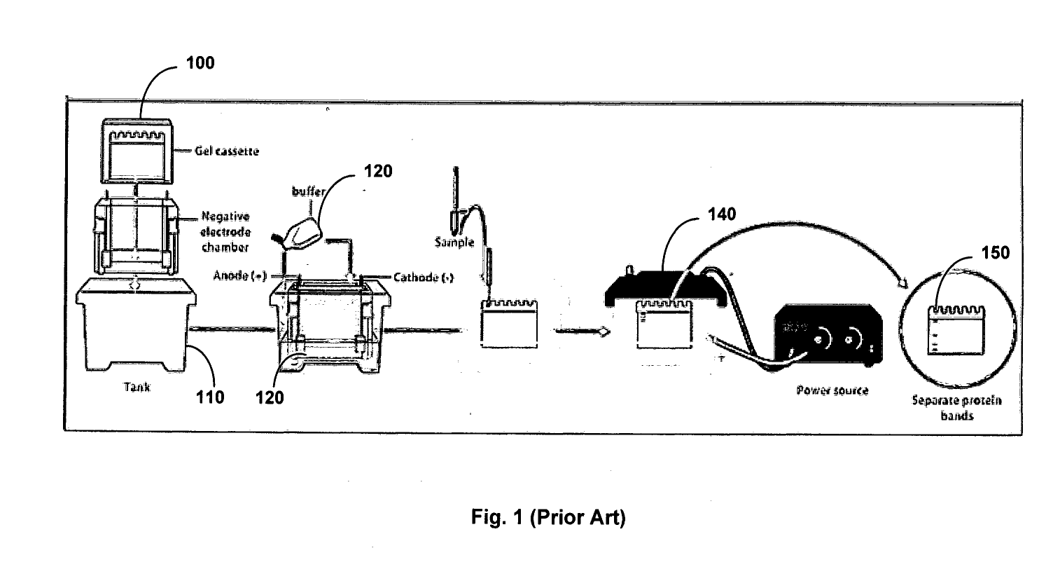

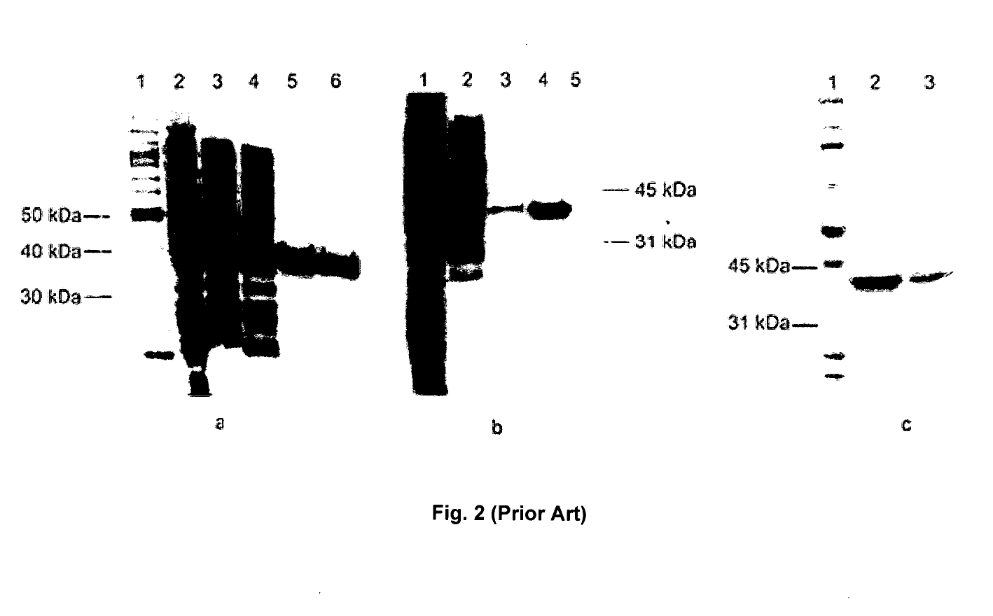

### DETAILED DESCRIPTION OF THE INVENTION

The present invention provides a solution that overcomes the limitations of existing PAGE systems by providing a new gel matrix device.

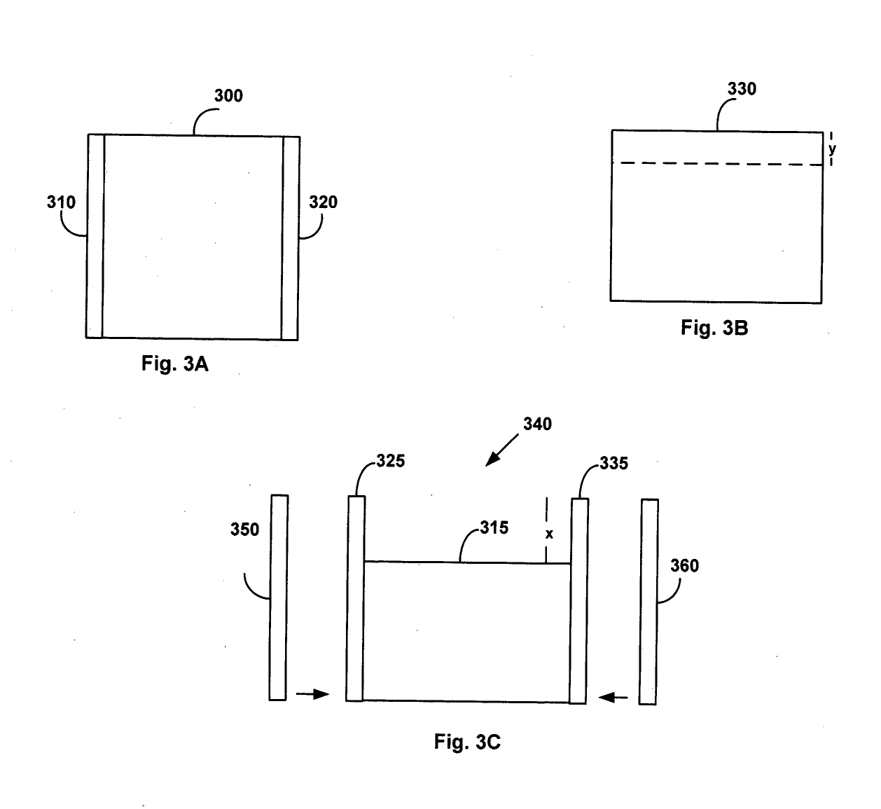

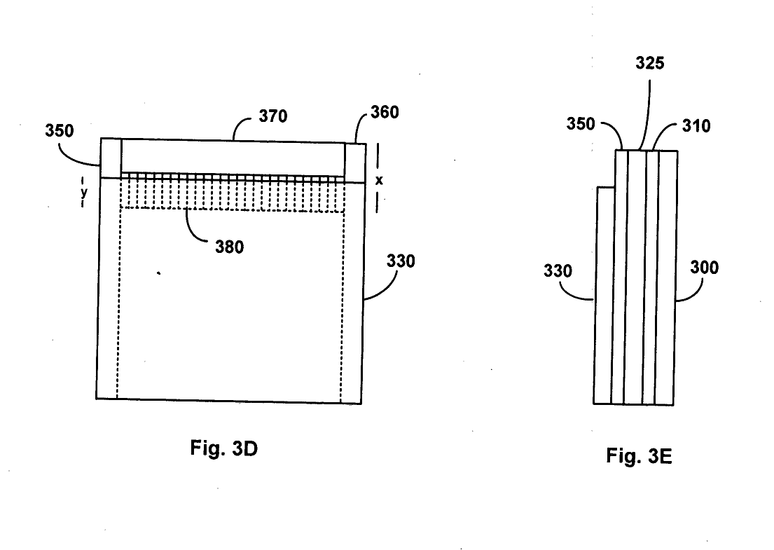

FIGS. 3A through 3E are schematic drawing showing the gel matrix device according to the present invention.

The device comprises three plates: A back plate 300 (FIG. 3A) with spacers 310, 320 on both vertical sides thereof, a front plate 330 (FIG. 3B), shorter than plate 300 and a middle plate 340 (FIG. 3C) having a middle part 315 shorter than plate 330, two side parts 325, 335 having the same height as back plate 300 and spacers 350, 360 on both vertical sides thereof, the spacers having the same height as spacers 310, 320.

FIG. 3D is a schematic drawing showing a front view of the assembled gel matrix device, comprising front plate 330, spacers 350, 360 shown behind front plate 330 and protruding above it and a comb comprising a handle 370 and teeth 380 inserted into the upper part of the device, above the height of the middle plate 340.

FIG. 3E is a side view of the device according to the present invention.

For producing the gel matrix device according to the present invention:
1. Bottom part is temporarily sealed to pour the gel. The temporary seal may comprise, for example, a sticker;
2. The structure is filled with the solution to be polymerized;
3. A comb is inserted at the top;
4. When gel has formed, it is packaged in SDS-PAGE running buffer and is ready for use.

In operation:
1. The comb is removed to reveal the wells formed in the upper part of the gel. Bottom seal is also removed.
2. The precast gel is loaded into the gel chamber and running buffer is added to top and bottom baths.
3. Samples to be analyzed are mixed with a Laemmli sample buffer and are boiled for 5 minutes and then loaded into the wells;
4. An electric current is run through the buffer.
5. The electricity travels through the gel and this moves the protein samples down the gel.
6. Once it reaches the partition (i.e. the middle plate 340 height) half the sample will migrate to the gel between the front plate 330 and the middle plate 340 and the other half will migrate to the gel between middle plate 340 and back plate 300. Note that this division assumes equal thickness of both gels. In the event that one gel is thicker than the other, the protein sample will be divided between them accordingly.
7. Once the samples have travelled down the gels, the electricity is stopped and the apparatus taken apart.

The operation described creates a mirror copy of the proteins by using the same gel and the same samples. The two identical results may now be further processed in different manners.

In an alternative embodiment of using the gel matrix device, the three plates may first be assembled and then different gel formulations inserted in the front compartment and in the back compartment.

This will not provide a mirror image but rather different information about the sample loaded (for example, one gel can be used to isolate large proteins and the other to focus on small proteins).

One of the gels may be thicker than the other, which can be useful in specific experiments. In short, by creating a second gel in the same run a variety of possibilities open up.

The essence of the invention is 1 sample=2 gels. The partition doubles the amount of data which can be obtained without adding extra steps, more material or more time.

Prototype

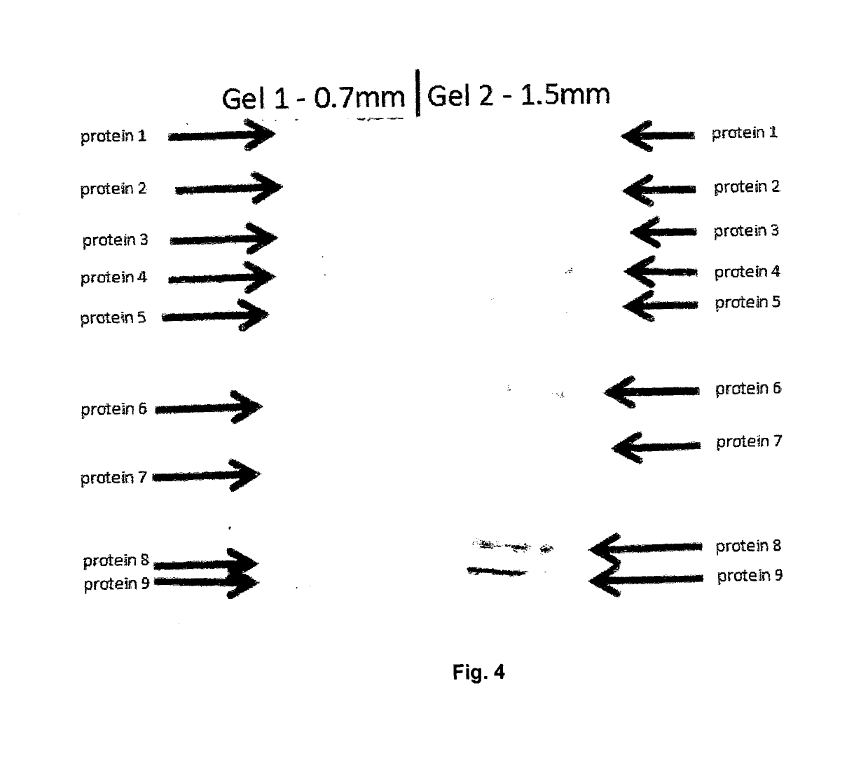

An initial prototype was prepared and tested and provided very encouraging results (see FIG. 4).

A standard molecular weight ladder was tested. This is a sample of pre-stained proteins of known sizes that are run as standards. Note that gel 2 is thicker than gel 1 and as a result the image is a bit stronger (image is clearer with less background). Due to uneven thickness of both gels the samples ran slightly differently; note proteins 8 and 9 are significantly lower in gel#1. This would not happen if both gels are exactly the same thickness. Alternatively, if a thicker gel is desired, the gel composition can be adjusted to offset the difference in thickness and will create an identical duplicate in both gels.

Various configurations of gels and plates are contemplated. For example:

Gel Configurations:
a. Standard two gel system, both gels are the same thickness and the same composition. This standard model yields two identical gels that can be analyzed using different methodologies. Another technique that is often used is the gradient gel—preparing a gel that ranges in concentration from 4% to 12%. In this configuration both front and back are the same thickness with both gels of the same gradient composition. Many argue that gradients provide better gel resolution (better overall separation of large and small proteins).
b. Two gels of the same thickness but with two different acrylamide compositions—for example 12% acrylamide in the back gel and 5% acrylamide in the front gel. This model provides excellent separation of small proteins in one gel and excellent separation of larger proteins in the second, thereby increasing the scope of the analysis.
c. Two gels of same thickness but one gel of single concentration and the other gel a gradient. This configuration may be used to test the efficacy of using a gradient as opposed to a fixed concentration gel.
d. Two gels, same thickness as in configuration (a), but with two gradients in the opposite direction—back gel 4% to 15% and front gel 15% to 4%. The back gel will separate out the large proteins and small proteins while the front gel will actually be less effective for those while providing improved resolution of mid-sized proteins.

Plate Configurations:
e. Here there is one thicker gel and one thinner gel. This is easily prepared by adjusting the thickness of the spacers. The huge advantage here is that sometimes protein bands need to be cut out (extracted) from the gel and maximal protein content is desired. The thick gel will provide the bulk of the protein for excising and processing while the thinner gel can be kept whole and used to validate or provide a complete uncut picture of the gel.
f. Here the spacers are thinner at the top and thicker at the bottom forming a triangular structure. Since proteins travel slower in thicker gels, this configuration may offer the same benefit as the gradient gel with better overall separation.
g. Same as configuration (f) but with the gels thick on top and thinner at the bottom.

Numerous combinations between the exemplary configurations may be possible, such as, creating the triangular structures with gradient gels, or creating a hybrid structures with a triangular back gel and a standard front gel. The configurations mentioned above are just a starting point for a huge number of potential combinations.

According to embodiments of the invention, one or more additional “middle” partitions may be assembled, to produce more than one copy of the gel or to enable use of more than two different gels simultaneously on the same samples. The limitation to the number of “middle” plates would be the thickness of the assembled device and the minimum amount of sample needed in each gel to produce meaningful results.

1. A gel matrix device for performing polyacrylamide gel electrophoresis, comprising:
a back plate having spacers on both vertical sides thereof;
a front plate, shorter than the back plate; and
a middle plate having a middle part shorter than the front plate, two side parts having the same height as the back plate and spacers on both vertical sides thereof, the spacers having the same height as the back plate spacers, wherein said middle plate divides the volume between said back and front plates into two compartments and wherein each one of said two compartments comprises gel up to the height of said middle plate,
and wherein the gel continues above the middle plate in an area common to the two compartments, said area comprising wells for sample loading.

2. A method of producing a gel matrix device for performing polyacrylamide gel electrophoresis, comprising:
providing a back plate having spacers on both vertical sides thereof;
providing a front plate, shorter than the back plate; and
providing a middle plate shorter than the front plate and having spacers on both vertical sides thereof, the spacers having the same height as the back plate spacers, wherein said middle plate divides the volume between said back and front plates into two compartments;
creating a structure by attaching said three plates;
sealing the sides of the structure with spacers;
removably sealing the bottom of the structure;
filling the structure with a solution to be polymerized; and
inserting a comb at the top of the structure.

3. A method of performing polyacrylamide gel electrophoresis, comprising:
providing the gel matrix device of claim 1;
removing wells formed by a comb inserted in the upper part of the gel;
loading the gel matrix device into a gel chamber and adding running buffer to internal and external baths;
mixing protein samples to be analyzed with Laemmli sample buffer and loading into the wells; and
running an electric current through the buffer,
whereby the protein samples move down the gel and are divided between both compartments.

4. The gel matrix device of claim 1, wherein the gels loaded into the two compartments have identical compositions.

5. The gel matrix device of claim 1, wherein the gels loaded into the two compartments have different compositions.

6. The gel matrix device of claim 1, wherein each spacer has a fixed thickness.

7. The gel matrix device of claim 1, wherein at least one spacer has a gradient thickness.

8. The gel matrix device of claim 1, wherein the back plate spacers and the middle plate spacers have identical thicknesses.

9. The gel matrix device of claim 1, wherein the back plate spacers and the middle plate spacers have different thicknesses.
